(19) United States
(12) Patent Application Publication
(10) Pub. No.: US 2010/0306166 A1
(43) Pub. Date: Dec. 2, 2010

(54) AUTOMATIC FACT VALIDATION

(75) Inventors: Patrick Pantel, Sunnyvale, CA (US); Alpa Jain, San Jose, CA (US)

Correspondence Address: Weaver Austin Villeneuve & Sampson - Yahoo!, P.O. BOX 70250, OAKLAND, CA, 94612-0250, US

(73) Assignee: Yahoo! Inc., Sunnyvale, CA (US)

(21) Appl. No.: 12/476,055

(22) Filed: Jun. 1, 2009

(51) Int. Cl. G06F 17/00; G06F 7/06; G06F 17/30

(52) U.S. Cl. 706/55; 707/E17.033; 707/E17.108; 707/E17.084

(57) ABSTRACT

The disclosed embodiments fulfill searches and determine the validity of a large set of noisy facts and rank the set of facts according to a validity score. Embodiments construct a fact graph by linking together facts that share a common relation structure and entity or instance of an argument. Facts are re-ranked and validated using link analysis processes which propagate weight (validity/authority) through the fact graph. The resulting weights for each fact are potentially combined with other scores (such as from fact extraction algorithms) in order to come up with a final ranking of the facts.

### BACKGROUND OF THE INVENTION

This invention relates generally to search systems and more particularly to the processing and assessment of facts used by the search systems.

Fact collections are mostly built using automatic or semi-automatic relation extraction techniques and wisdom of the crowd methods, rendering them inherently noisy. The noise makes reliance upon and usage of the facts problematic.

### SUMMARY OF THE INVENTION

The disclosed embodiments fulfill searches and determine the validity of a large set of noisy facts and rank the set of facts according to a validity score. Search computer systems and associated methods implemented therein for determining validity thresholds are disclosed.

Embodiments construct a fact graph by linking together facts that share a common entity (e.g., the fact “James Cameron, director-of, Titanic” is linked to the fact “Leonardo DiCaprio, acted-in, Titanic” because they share the movie entity “Titanic”). Facts are reranked and validated using link analysis processes (e.g., PageRank) which propagate weight (validity/authority) through the fact graph. The resulting weights for each fact are potentially combined with other scores (such as from fact extraction algorithms) in order to come up with a final ranking of the facts.

Facts are returned to web search users in the form of Y! Shortcuts, other direct displays, rich abstracts, and search assist. This may be in addition to search query results. Many facts on the Web must be extracted from unstructured Web documents or semi-structured sources. Extraction methods are very noisy and embodiments of the invention determine the (relative) validity of the facts using global analysis on the relations between facts. Fact display tools (such as Yahoo! Shortcuts) have access to and can present a greatly increased collection of reliable/screened/validated facts.

In all but very small fact bases, relations share an argument type, such as movie for the relations discussed above. Embodiments apply graph-based ranking techniques as will be discussed below. A preferred technique performs random walk models on facts. This technique results in an improvement over state-of-the-art ranking methods, as will also be described below.

When two fact instances from two relations share the same value for a shared argument type, then the validity accorded to both facts is increased. Conversely, an incorrect fact instance will tend to match a shared argument with other facts far less frequently, and the validity accorded to one or both of the facts will be low or decreased.

For example, consider the following four facts from the relations acted-in, director-of, and is-actor:

t1: acted-in (Psycho, Anthony Perkins)

t2: acted-in (Walt Disney Pictures, Johnny Depp)

t3: director-of (Psycho, Alfred Hitchcock)

t4: is-actor (Anthony Perkins, Actor)

The confidence in the validity of t1 increases with the knowledge of t3 and t4 since the argument movie is shared with t3 and actor with t4. Similarly, t1 increases our confidence in the validity of t3 and t4. For t2, we expect to find few facts that will match a movie argument with Walt Disney Pictures. Facts that share the actor argument Johnny Depp with t2 will increase its validity, but the lack of matches on its movie argument will decrease its validity.

One aspect of the invention relates to a computer system for providing search results to users. The computer system is configured to: identify arguments common to relations in a collection of data; generate a group of relations based on the identified common arguments; construct a graph based representation of facts using the generated group of relations and identified common arguments; perform link analysis with a random walk technique over the constructed graph based representation of facts, generating a score for each graph based representation of a fact; rank the facts in each relation by the generated score; and provide a response to a search query, the response incorporating at least one ranked fact.

A further understanding of the nature and advantages of the present invention may be realized by reference to the remaining portions of the specification and the drawings.

### BRIEF DESCRIPTION OF THE DRAWINGS

FIG. 1 illustrates a flow chart of a process according to an embodiment of the invention.

FIG. 2A illustrates a flow chart of a process according to an embodiment of the invention.

FIG. 2B shows a fact graph drawing for the example in Table 1.

FIGS. 3A, 3B, and 3C are flow charts illustrating the use of the facts and re-ranked facts.

FIG. 4 is a simplified diagram of a computing environment in which embodiments of the invention may be implemented.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

Search engine or other computer systems according to the invention utilize techniques and algorithms to validate and re-rank fact bases leveraging global constraints imposed by semantic arguments predicated by the relations between facts.
Relation: We denote an n-ary relation r with typed arguments t1, t2 . . . tn as r (t1, t2 . . . tn). Binary relations are discussed for exemplary purposes, although embodiments encompass use of any degree (unary, ternary . . . etc.) of relations. An example of a generic relation is: acted-in (actor, movie), wherein actor is a first parameter or argument type and movie is a second parameter or argument type.
Fact: A fact is an instance of a relation. For example, acted-in (Psycho, Anthony Perkins) is a fact from the relation acted-in (movie, actor). Each of movie and actor may be referred to as parameters, whereas the actual instances Psycho and Anthony Perkins are referred to as arguments.
Fact base: A fact base is a large collection of facts from several relations. Textrunner and Freebase are example fact bases (note that these resources also contain knowledge beyond facts such as entity lists and ontologies.)
Fact farm: A fact farm is a subset of interconnected relations in a fact base that share arguments among them.

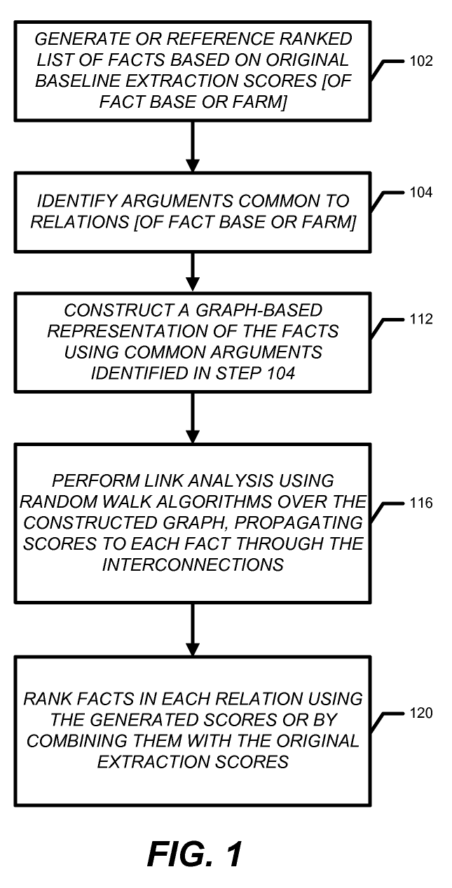

FIG. 1 illustrates a flow chart of a process according to an embodiment of the invention.

Fact bases are built in many ways, including semi-supervised relation extraction methods and wisdom of the crowd methods, for example. Extractors iteratively learn patterns that can be instantiated to identify new facts from a relatively small set of seed facts. Example pattern types include surface patterns with or without wildcards, as well as lexico-syntactic or lexico-semantic patterns. To reflect their confidence in an extracted fact, extractors assign an extraction score with each fact. Similarly, many extractors assign a pattern score to each discovered pattern. In each iteration, the highest scoring patterns and facts are saved, which are used to seed the next iteration. After a fixed number of iterations or when a termination condition is met, the final list of instantiated facts are ranked by their extraction scores, and an appropriate threshold is applied to select the output list of facts. This is represented by step 102 of FIG. 1. For further information on methods of generating such ranked lists, please refer to: Patrick Pantel and Marco Pennacchiotti. 2006, Espresso: leveraging generic patterns for automatically harvesting semantic relations, In Proceedings of ACL/COLING-06, pages 113-120, Association for Computational Linguistics; and Marius Pasca, Dekang Lin, Jeffrey Bigham, Andrei Lifchits, and Alpa Jain, 2006, Organizing and searching the world wide web of facts—step one: The one-million fact extraction challenge, In Proceedings of AAAI-06., which are hereby incorporated by reference in the entirety.

Facts that share arguments with many facts are more reliable than those that share arguments with few facts. Embodiments determine the reliability of facts according to this principle, as will be described below.

Referring again to FIG. 1, in step 104, the system will identify arguments common to the relations. This may be done in the fact base or any subset thereof, i.e. the “fact farm.” In step 112, the system will construct a graph-based representation of the extracted facts using the arguments identified in step 104.

In mathematics and computer science, graph theory is the study of graphs: mathematical structures used to model pairwise relations between objects from a certain collection. A “graph” or “graph based representation” in this context and as disclosed in this document refers to a collection of vertices or ‘nodes’ and a collection of edges that connect pairs of vertices. A graph may be undirected, meaning that there is no distinction between the two vertices associated with each edge, or its edges may be directed from one vertex to another. The mathematical structure of the graph need not be drawn or plotted (a graph drawing).

Graphs are represented graphically by drawing a dot for every vertex, and drawing an arc between two vertices if they are connected by an edge. If the graph is directed, the direction is indicated by drawing an arrow.

A graph drawing should not be confused with the graph itself (the abstract, non-graphical structure) as there are several ways to structure the graph drawing. The main aspect is which vertices are connected to which others and by how many edges, not the exact layout. In practice it is often difficult to decide if two drawings represent the same graph. Depending on the problem domain, some layouts may be better suited and easier to understand than others.

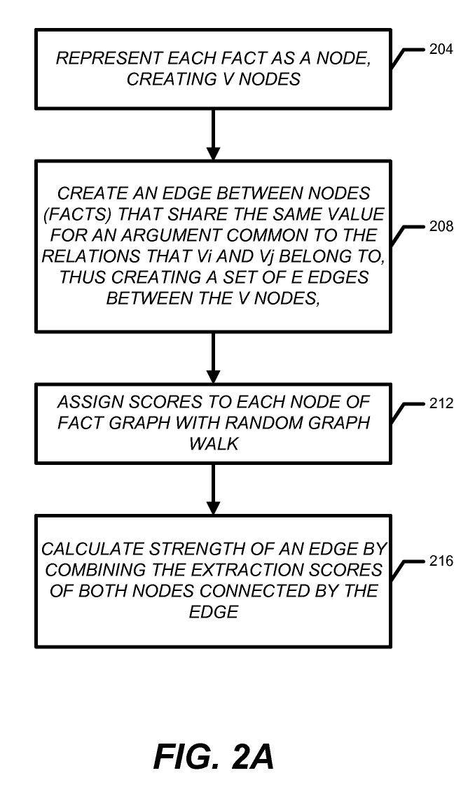

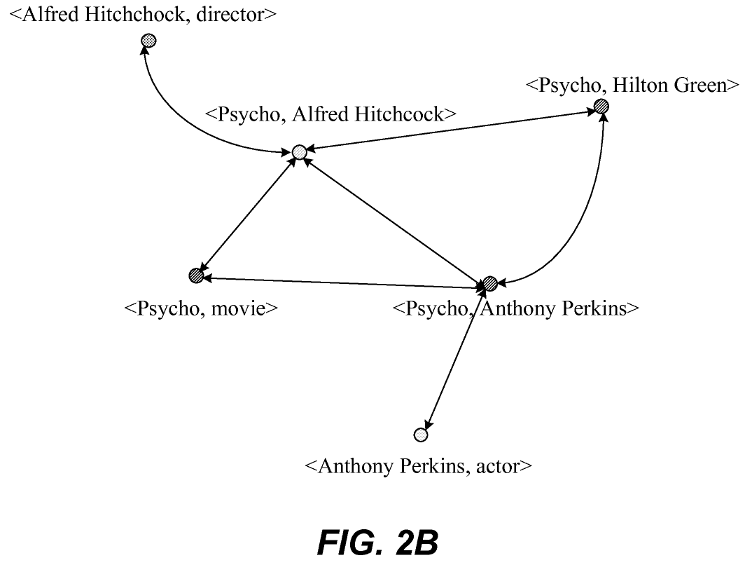

The graph and graph-based representation will be discussed later in greater detail with regard to FIG. 2. Returning to FIG. 1, in step 116, the system will perform link analysis using random walk algorithms/techniques over the generated graph, propagating scores to each fact through the interconnections.

In Step 120, the system will rank facts in each relation using the scores generated in step 108. The scores may be used alone, or in conjunction with other factors, such as the original extraction scores referred to in step 102. For example, two exemplary ways the original ranked list O (step 102) and the re-ranked list G (step 120) may be combined are as follows.

R-Avg: The first combination method computes the average of the ranks obtained from the two lists. Formally, if O(i) is the original rank for fact i and G(i) is the rank for i in the re-ranked list, the combined rank M(i) is computed as:

$$M ( i ) = \frac{O ( i ) + G ( i )}{2} .$$

R-Wgt: The second method uses a weighted average of the ranks from the individual lists:

$$M ( i ) = \frac{{ω}_{o} \cdot O ( i ) + ( 1 - {ω}_{o} ) \cdot G ( i )}{2}$$

In practice, this linear combination can be learned, and will vary with different fact bases. One value for ωₒ is 0.4, based on observations over an independent training set. Several other combination functions (e.g. min and max functions) could also be applied to this task, as mentioned above.

FIG. 2A is a flow chart illustrating an embodiment of graph representation of facts. The system will represent each fact as a node, creating V nodes, as seen in step 204. In step 208, the system will create an edge between nodes (facts) that share the same value form an argument common to the relations that Vᵢ and Vⱼ belong to, thus creating a set of E edges between the V nodes.

For example, FIG. 2B shows a fact graph drawing for the example in Table 1, below, centered around the fact t1.

TABLE 1
Facts share arguments across relations
which can be exploited for validation.

| Relations | id: | Facts |
|---|---|---|
| acted-in | t_{1:} | (Psycho, Anthony Perkins) |
| | t_{2:} | (Walt Disney Pictures, Johnny Depp) |
| director-of | t_{3:} | (Psycho, Alfred Hitchcock) |
| producer-of | t_{4:} | (Psycho, Hilton Green) |
| is-actor | t_{5:} | (Anthony Perkins, actor) |
| | t_{6:} | (Johnny Depp, actor) |
| is-director | t_{7:} | (Alfred Hitchcock, director) |
| is-movie | t_{8:} | (Psycho, movie) |

The graph representation discussed above is just one of many possible options that may be employed by embodiments of the invention. For instance, instead of representing facts by nodes, nodes could represent the arguments of facts (e.g., Psycho) and nodes could be connected by edges if they occur together in a fact.

In step 212 the system assigns scores to each node of the fact graph by performing a random graph walk, a type of graph based ranking technique or algorithm. While the random walk model is preferred, any graph based ranking technique may be employed. As previously mentioned, connected facts increase confidence in those facts. This confidence is modeled by propagating extraction scores through the fact graph similarly to how authority is propagated through a hyperlink graph of the Web (e.g. PageRank). Given a directed graph G=(V,E) with V vertices and E edges, I(u) is the set of nodes that link to a node u and O(v) is the set of nodes linked by v. Then, the importance of a node u is defined as:

$$p ( u ) = {\sum }_{v ∈ I ( u )} \frac{p ( v )}{\vert O ( v ) \vert} \qquad ( 1 )$$

The PageRank algorithm iteratively updates the scores for each node in G and terminates when a convergence threshold is met. To guarantee the algorithm's convergence, G must be irreducible and aperiodic (i.e., a connected graph). The first constraint can be easily met by converting the adjacency matrix for G into a stochastic matrix (i.e., all rows sum up to 1.) To address the issue of periodicity, the following modification is made to the above PageRank equation:

$$p ( u ) = \frac{1 - d}{\vert V \vert} + d \cdot {\sum }_{v ∈ I ( u )} \frac{p ( v )}{\vert O ( v ) \vert} \qquad ( 2 )$$

where d is a damping factor between 0 and 1, which is commonly set to 0.85. PageRank can be viewed as modeling a “random walker” on the nodes in G and the score of a node, i.e. the PageRank, determines the probability of the walker arriving at this node. Stationary scores can also be computed for undirected graphs after replacing each undirected edge by a bi-directed edge. Recall that the edges in a fact graph are bi-directional. While PageRank may be employed, other graph analysis techniques may also be employed, for example the HITS by Kleinberg. For more information on HITS, please refer to Jon Michael Kleinberg. 1999, Authoritative sources in a hyperlinked environment, Journal of the ACM, 46(5):604-632, hereby incorporated by reference in the entirety.

In step 216, the strength of an edge is calculated by combining the extraction scores of both nodes connected by the edge. This may be done according to the following methods.

Pln: The first method applies the traditional Page-Rank model to the fact graph and computes the score of a node u using Equation 2.

Dst: One improvement over Pln is to distinguish between nodes using the extraction scores of the facts associated with them: extraction methods such as the variation of Pasca et al. discussed above, assign scores to each output fact to reflect a confidence in it. A higher scoring node that connects to u should increase the importance of u more than a connection from a lower scoring node. I(u) denotes the set of nodes that link to u, and O(v) denotes the set of nodes linked by v. Then, if w(u) is the extraction score for the fact represented by node u, the score for node u is defined as:

$$p ( u ) = \frac{1 - d}{\vert V \vert} + d \cdot {\sum }_{v ∈ I ( u )} \frac{ω ( v ) \times p ( v )}{\vert O ( v ) \vert}$$

where ω(υ) is the confidence score for the fact represented by v by the underlying extraction method. Naturally, other (externally derived) extraction scores can also be substituted for ω(υ).

Avg: In this method the strength of an edge is further determined by combining the extraction scores of both nodes connected by an edge. Specifically,

$$p ( u ) = \frac{1 - d}{\vert V \vert} + d \cdot {\sum }_{v ∈ I ( u )} \frac{avg ( u , v ) \times p ( v )}{\vert O ( v ) \vert}$$

where avg(u, v) is the average of the extraction scores assigned to the facts associated with nodes u and v.

Nde: In addition to using extraction scores, in another embodiment or method can the strength of a node is derived from the number of distinct relations connected to it. For instance, in FIG. 2B, t1 is linked to four distinct relations, namely, director-of, producer-of, is-actor, is-movie, whereas, t2 is linked to one relation, namely, is-actor. We compute p(u) as:

$$p ( u ) = \frac{1 - d}{\vert V \vert} + d \cdot {\sum }_{v ∈ I ( u )} \frac{( α \cdot ω ( v ) + ( 1 - α ) \cdot r ( v ) ) \times p ( v )}{\vert O ( v ) \vert}$$

where ω(υ) is the confidence score for node v and r(v) is the fraction of total number of relations in the farm that contain facts with edges to v.

Dangling nodes in fact graphs (i.e. nodes with no associated edges) may be of importance. This is unlike in the area of web pages, where dangling nodes are considered to be of low importance. Fact graphs are relatively sparse, causing them to have valid facts with no counterpart matching arguments in other relations. This is due to the nature of the facts, but also may be due to several reasons such as extractors with less than perfect recall. In certain embodiments, dangling nodes are not re-ranked, in other words, while connected nodes are re-ranked, the original rank positions for dangling nodes may be maintained. Of course, in some embodiments, dangling nodes may also be re-ranked. This re-ranking may be by the random walk as described above, or may be achieved by adding an additional weighting factor to the dangling nodes to minimize any decrease in importance by the random walk, or page rank methodology.

Facts may be verified by human assessment and/or by computing the precision of a list L against a gold-set S of facts computed as

$$\frac{\vert L ⋂ S \vert}{\vert S \vert} .$$

Facts may also be further verified by computing the average precision of a list L as:

$${A}_{p} ( L ) = \frac{{\sum }_{i = 1}^{\vert L \vert} P ( i ) \cdot isrel ( i )}{{\sum }_{i = 1}^{\vert L \vert} isrel ( i )}$$

where P(i) is the precision of L at rank i, and isrel(i) is 1 if the fact at rank i is in S, and 0 otherwise. Precision values may also be assessed at varying ranks in the list.

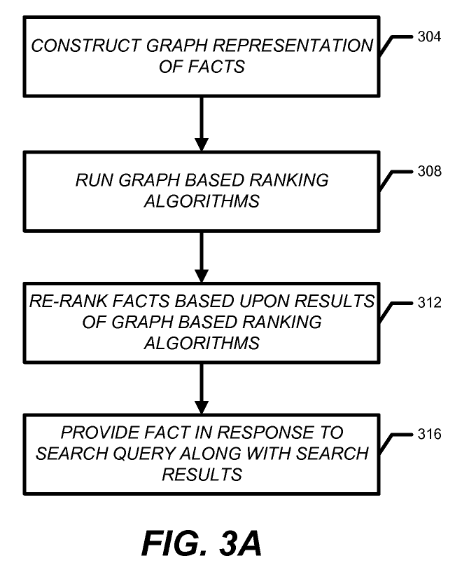

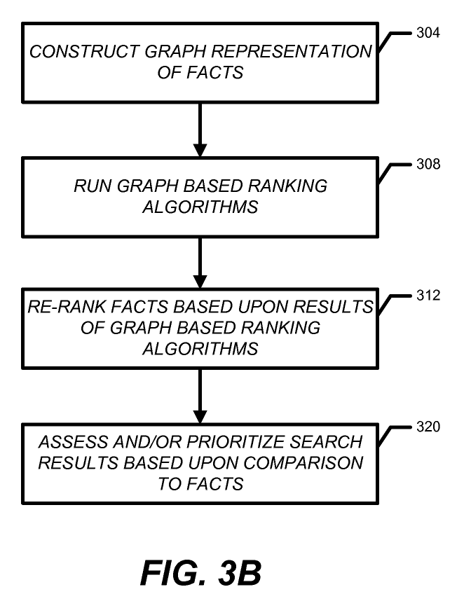

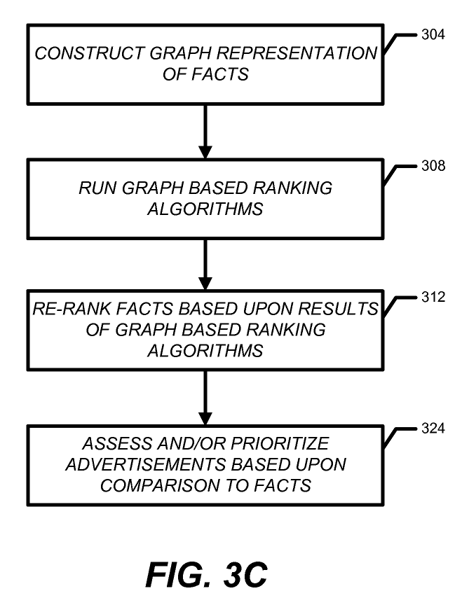

FIGS. 3A, 3B, and 3C are flow charts illustrating the use of the facts and re-ranked facts. In step 304, the system constructs a graph representation of facts. In step 308, the system runs graph based ranking techniques, and step 312 the facts are re-ranked based on the results of the techniques and in some embodiments on the original ranks. A search system such as Yahoo! may then provide the fact or facts in response to a query, along with the typical search results (links), as seen in step 316. Alternatively, or in addition to providing the facts as in step 316, the facts may be used as criteria in formulating the search results themselves, as seen in step 320. For example, a web page or other source of information at the URL provided by a link in a search result may be evaluated by comparing one or more facts, the reliability having been assessed as described herein, with information present in the page. For example, if a user presents a query such as “population of Kansas,” or “airspeed velocity of a swallow,” the fact (i.e. population or velocity value) can be compared against individual query results. If the value within a result differs appreciably from what is considered a reliable or highly ranked fact, the search engine may present the result at a lower level ranking and/or in a less desirable position than if it correlated with the fact.

Similarly, as shown in step 324, an advertisement provided in conjunction with a search result, or otherwise, may be evaluated by comparing one or more facts, the reliability having been assessed as described herein, with information present in the advertisement. Likewise, abstracts (a.k.a. snippets) of information within documents, web pages, files, or other sources of information may also be evaluated by comparing one or more facts, the reliability having been assessed as described herein. This is advantageous because advertisement and abstracts with known facts are preferred to those with unknown facts.

Example Evaluation and Results

For evaluation purposes, a ranked list was generated using the extraction scores output by an extractor. This method will be referred to as Org (original). A fact graph was then generated and the facts re-ranked. The system ran Avg, Dst, Nde, R-Avg, and R-Wgt on this fact graph and using the scores re-ranked the facts for each of the relations. The example results for the acted-in and director-of relations is shown in the table below.

TABLE 2
Average precision for acted-in for varying
proportion of fact graph of MOVIES.

| | Average precision | | |
|---|---|---|---|
| Method | 30% | 50% | 100% |
| Org | 0.51 | 0.39 | 0.38 |
| Pln | 0.44 | 0.35 | 0.32 |
| Avg | 0.55 | 0.44 | 0.42 |
| Dst | 0.54 | 0.44 | 0.41 |
| Nde | 0.53 | 0.40 | 0.41 |
| R-Avg | 0.58 | 0.46 | 0.45 |
| R-Wgt | 0.60 | 0.56 | 0.44 |

Table 2 compares the average precision for acted-in, with the maximum scores highlighted for each column.

The example also confirms initial observations: using traditional PageRank (Pln) is not desirable for the task of re-ranking facts. Embodiments utilizing modifications to the PageRank algorithm (e.g., Avg, Dst, Nde) consistently outperform the traditional PageRank algorithm (Pln). The results also underscore the benefit of combining the original extractor ranks with those generated by the graph-based ranking algorithms with R-Wgt consistently leading to highest or close to the highest average precision scores.

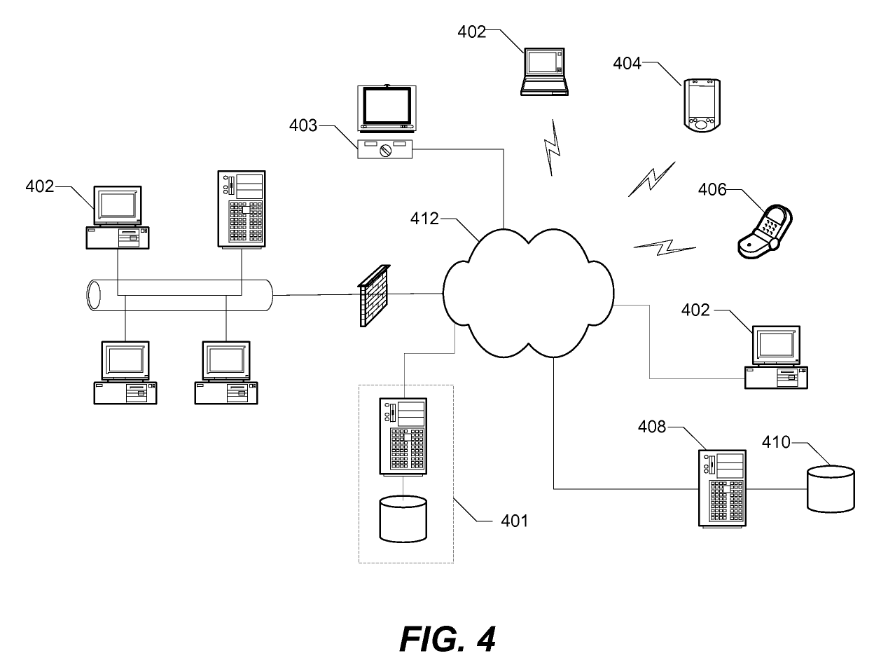

The above techniques are implemented in a search provider computer system. Such a search engine or provide system may be implemented as part of a larger network, for example, as illustrated in the diagram of FIG. 4. Implementations are contemplated in which a population of users interacts with a diverse network environment, accesses email and uses search services, via any type of computer (e.g., desktop, laptop, tablet, etc.) 402, media computing platforms 403 (e.g., cable and satellite set top boxes and digital video recorders), mobile computing devices (e.g., PDAs) 404, cell phones 406, or any other type of computing or communication platform. The population of users might include, for example, users of online email and search services such as those provided by Yahoo! Inc. (represented by computing device and associated data store 401).

Regardless of the nature of the search service provider, searches may be processed in accordance with an embodiment of the invention in some centralized manner. This is represented in FIG. 4 by server 408 and data store 410 which, as will be understood, may correspond to multiple distributed devices and data stores. The invention may also be practiced in a wide variety of network environments including, for example, TCP/IP-based networks, telecommunications networks, wireless networks, public networks, private networks, various combinations of these, etc. Such networks, as well as the potentially distributed nature of some implementations, are represented by network 412.

In addition, the computer program instructions with which embodiments of the invention are implemented may be stored in any type of tangible computer-readable media, and may be executed according to a variety of computing models including a client/server model, a peer-to-peer model, on a stand-alone computing device, or according to a distributed computing model in which various of the functionalities described herein may be effected or employed at different locations.

The above described embodiments have several advantages. They improve the accuracy of search results provided to a user. While search results based solely upon standard techniques will provide relevant results in response to a query without regard to accuracy of the results, search results provided by embodiments of the present invention will provide not only the most relevant, but also the most relevant and accurate results. This is especially noteworthy as people now rely on search engines to fulfill all manner of queries. For example, while a user may go directly to a site that provides what the “wisdom of the crowd” determines to be a fact (e.g. Wikipedia), the user might also simply go to a search engine. In such an instance, the user will receive not only search results, but also the benefit of a fact simultaneously, eliminating the need to perform two queries at different sites or providers.

In addition or in the alternative, in embodiments where the content of the pages or sites identified in the search are assessed for consistency with the facts, the results presented will have improved fact based accuracy.

While the invention has been particularly shown and described with reference to specific embodiments thereof, it will be understood by those skilled in the art that changes in the form and details of the disclosed embodiments may be made without departing from the spirit or scope of the invention.

In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A computer system for providing search results to users, the computer system configured to:
identify arguments common to relations in a collection of data;
generate a group of relations based on the identified common arguments;
construct a graph based representation of facts using the generated group of relations and identified common arguments;
perform link analysis with a random walk technique over the constructed graph based representation of facts, generating a score for each graph based representation of a fact;
rank the facts in each relation by the generated score; and
provide a response to a search query, the response incorporating at least one ranked fact.

2. The computer system of claim 1, wherein the computer system is further configured to generate or reference a baseline ranked list of facts from baseline extraction scores.

3. The computer system of claim 2, wherein the baseline extraction scores are generated by performing an extraction without a subsequent link analysis comprising a random graph walk analysis.

4. The computer system of claim 2, wherein the baseline extraction scores are generated by performing an extraction with a subsequent link analysis comprising a random graph walk analysis.

5. The computer system of claim 2, wherein in order to rank the facts in each relation the computer system is configured to combine a baseline extraction score with a score determined by the link analysis.

6. The computer system of claim 5, wherein the computer system is configured to average a rank suggested by the baseline ranked list and a rank determined by the link analysis.

7. The computer system of claim 5, wherein the computer system is configured to perform a weighted average of a rank suggested by the baseline ranked list and a rank determined by the link analysis.

8. The computer system of claim 1, wherein in being configured to perform a link analysis the computer system is further configured to represent each fact as a node.

9. The computer system of claim 1, wherein in being configured to perform a link analysis the computer system is further configured to create an edge between nodes that share the same value for an argument common to the relations of the nodes.

10. The computer system of claim 1, wherein in being configured to perform a link analysis the computer system is further configured to assign scores to each node with the random walk technique.

11. The computer system of claim 9, wherein in being configured to perform a link analysis the computer system is further configured to calculate a strength of an edge between two nodes by combining the extraction score of both nodes connected by the edge.

12. The computer system of claim 1, wherein in being configured to provide a response to a search query incorporating at least one ranked fact, the computer system is configured to present the at least one ranked fact together with search results.

13. The computer system of claim 1, wherein in being configured to provide a response to a search query incorporating at least one ranked fact, the computer system is configured to determine if each of a plurality of search results is consistent with the at least one ranked fact.

14. The computer system of claim 13, wherein the computer system is further configured to rank the plurality of search results based in part upon the determined consistency with the at least one ranked fact, and to present the search results according to the rank based in part upon the determined consistency.

15. The computer system of claim 1, wherein the computer system is further configured to provide an advertisement in response to a search query, the advertisement evaluated for consistency with at least one ranked fact.

16. A computer system for providing search results to users, the computer system comprising a network of search provider servers configured to:
identify arguments common to relations in a collection of data;
generate a group of relations based on the identified common arguments;
construct graph based representation of facts using the generated group of relations and identified common arguments;
represent each graph based representation of a fact as a node;
create an edge between nodes that share the same value for an argument common to the relations of the nodes connected by the edge;
assign scores to each node representing a fact with a random walk technique;
rank the nodes and associated represented facts in each relation by the score; and
formulate and provide a response to a search query, the response incorporating at least one ranked fact.

17. The computer system of claim 16, wherein in being configured to perform a link analysis the computer system is further configured to calculate a strength of an edge between two nodes by combining the score of the nodes connected by the edge.

18. A computer system for providing search results to users, the computer system configured to:
identify arguments common to relations in a collection of data;
generate a group of relations based on the identified common arguments;
construct a graph based representation of facts using the generated group of relations and identified common arguments;
perform link analysis with a random walk technique over the constructed graph based representation of facts, generating a score for each graph based representation of a fact;
rank the facts in each relation by the generated score; and
evaluate search results for consistency with the ranked facts.

19. The computer system for providing search results to users of claim 18, the computer system further configured provide the search results in an order based in part upon the consistency with the ranked facts.
